(19) United States
(12) Patent Application Publication
(10) Pub. No.: US 2003/0192187 A1
(43) Pub. Date: Oct. 16, 2003

(54) Firefighter's tool

(76) Inventor: Jesse L. Bean, Dallas, TX (US)

Correspondence Address: KENNETH R. GLASER, MICHAEL E. MARTIN, GARDERE WYNNE SEWELL LLP, 1601 ELM STREET, SUITE 3000, DALLAS, TX, 75201, US

(21) Appl. No.: 10/121,994

(22) Filed: Apr. 12, 2002

(51) Int. Cl. B02C 18/00; B25D 3/00

(52) U.S. Cl. 30/164.6; 30/277

(57) ABSTRACT

A firefighter's wrecking tool or pike pole includes a first elongated tubular pole section connected to a penetrating tip assembly at one end and to a second pole section at its opposite end. The second pole section supports a manually activated reciprocable piston hammer slidably mounted on the second pole section and engageable with spaced apart anvils secured to the tool for receiving repeated impact blows to facilitate use of the tool. The piston hammer may be locked in a position for carrying and manipulating the tool by a thumbscrew or by a sleeve type locking member.

### BACKGROUND OF THE INVENTION

Firefighters often encounter firefighting situations wherein a tool is required to penetrate wall or ceiling paneling and pull the paneling away from the wall or ceiling in order to gain access to sources of fire for extinguishing such sources. Firefighting tools are known which are often called wrecking tools, pike poles or fire hooks. Conventional firefighter wrecking tools or pike poles comprise an elongated pole-like member with a penetrating spike or cutting blade mounted on the distal end thereof for penetration of a wall or ceiling panel to form a hole therein and to provide leverage for pulling the wall or ceiling panel away from its support structure to gain access to a source of fire. Conventional wrecking tools or pike poles do not, in many instances, provide enough mechanical advantage or leverage to easily pull stout wall or ceiling paneling away from supporting studs or ceiling joists, for example. Moreover, it is difficult to effectively grasp, push or pull on conventional wrecking tools or pike poles when the firefighter is dressed in full protective clothing, gloves and breathing equipment, for example.

In order to improve on the ability to push or pull paneling away from walls or ceilings, one type of firefighting tool has been developed which includes a two part pole with interconnected telescoping pole sections whereby a firefighter may grasp the pole, ram it through a wall or ceiling panel and then reciprocate one section of the pole with respect to the other to gain some mechanical advantage by imparting impact blows to the cutting or panel penetrating end of the tool. However, this type of firefighting tool also suffers from its inability to be easily manipulated when a firefighter is dressed in cumbersome protective clothing and gloves and/or is carrying breathing equipment. Moreover, prior art wrecking tools do not allow for gaining more mechanical advantage or energy delivered to the working end of the tool by assistance from additional firefighters.

Accordingly, there has been a strongly felt need for improvements in firefighter's wrecking tools or so-called pike poles which can be more easily carried and manipulated for ramming the penetrating end of the tool through a wall or ceiling panel and wherein the tool is configured for imparting added energy in the form of impact blows to either aid in penetrating wall or ceiling paneling and/or provide forces necessary to remove paneling from walls or ceilings. It is to these ends that the present invention has been developed.

### SUMMARY OF THE INVENTION

The present invention provides an improved firefighter's wrecking tool or pike pole. In accordance with one aspect of the present invention, a firefighter's wrecking tool is provided which includes an elongated pole member, a replaceable cutting or penetrating blade mounted at one end thereof and a piston hammer mounted for reciprocating sliding movement on the pole member for imparting impact blows in opposite directions to the pole member and the cutting or penetrating blade to assist in penetrating a wall or ceiling panel and, particularly, in removing or tearing away wall or ceiling paneling, for example.

In accordance with another aspect of the present invention, a firefighter's wrecking tool or pike pole is provided which includes a reciprocating piston hammer which is mounted in sleeved relationship over a lower part of the pole and which is engageable with spaced apart anvils for delivering impact blows in opposite directions to the pole and to a cutting or penetrating blade or tip member mounted at one end of the pole. The reciprocating piston hammer is provided with a handle which may be easily grasped by the firefighter handling the pole or by another firefighter who may assist in use of the tool. The piston hammer may be locked in a fixed position during transport of the tool to aid in handling the tool when entering or leaving the scene of a fire and during use of the tool when ramming or penetrating action is required.

In accordance with another aspect of the present invention, a firefighter's wrecking tool is provided which includes an elongated two part pole-like structure including a first or upper pole part formed as a steel or aluminum tube and adapted to support a cutting or penetrating tip or blade at one end thereof in such a way that the cutting or penetrating tip may be interchanged or replaced as needed. The firefighter's tool also includes a second pole part which may be secured to the first pole part in such a way that either one of the pole parts may be replaced while the other pole part is reused. Spaced apart anvil members are supported on the pole for transferring impact blows through the pole to the cutting or penetrating blade.

In accordance with yet another aspect of the invention, a firefighter's wrecking tool is provided which includes a combination of handles which facilitate ease of manipulation and use and the application of greater forces in driving or forcing the tool to penetrate wall or ceiling paneling, for example. One of the handles is attached to a reciprocating piston hammer and the piston hammer may be easily locked in a fixed position or unlocked for reciprocation to impart impact blows to the pole. Two embodiments of a quick release piston hammer locking mechanism are provided for the tool of the invention.

Still further, the present invention provides an improved firefighter's tool which is formed of components of superior materials and strength and dimensional proportions.

Those skilled in the art will further appreciate the above-mentioned advantages and superior features of the invention upon reading the detailed description which follows in conjunction with the drawings.

### BRIEF DESCRIPTION OF THE DRAWINGS

FIG. 1 is a side elevation of a firefighter's tool in accordance with the present invention;

FIG. 2A is a longitudinal section view of the upper portion of the tool and taken generally along the line 2-2 of FIG. 1;

FIG. 2B is a longitudinal section view of the lower portion of the tool and also taken generally along the line 2-2 of FIG. 1;

FIG. 3 is a detail view, partially broken away, showing an alternate embodiment of a locking mechanism for locking the reciprocating piston hammer in a fixed position with respect to the pole part of the tool; and

FIG. 4 is a detail elevation view of an alternate embodiment of a lower pole section for the tool of the present invention.

### DETAILED DESCRIPTION OF PREFERRED EMBODIMENTS

In the description which follows like parts are marked throughout the specification and drawing with the same reference numerals, respectively. The drawings are not necessarily to scale and certain features may be shown in somewhat schematic or simplified form in the interest of clarity and conciseness.

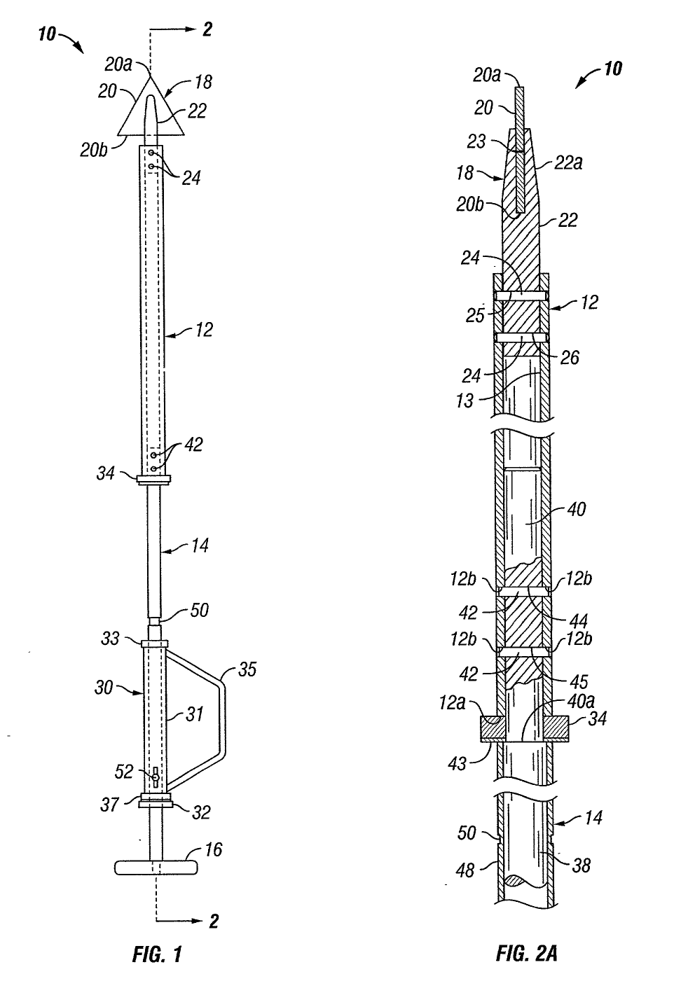

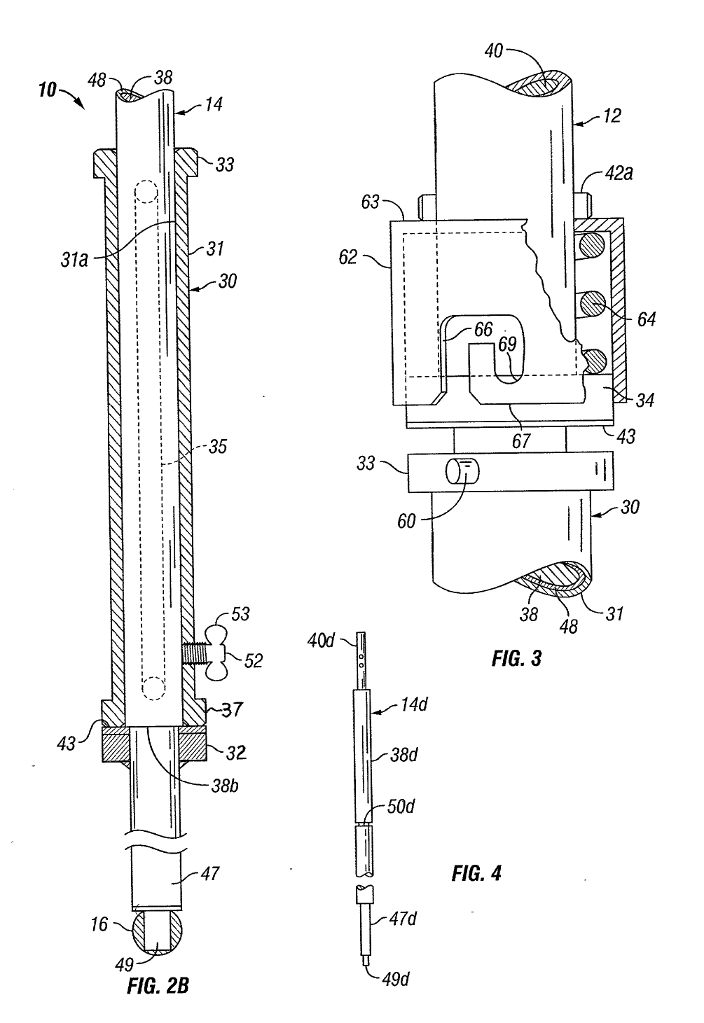

Referring primarily to FIG. 1, there is illustrated a firefighter's tool in accordance with the invention and generally designated by the numeral 10. The firefighter's tool 10 is characterized as an elongated generally cylindrical pole like structure including a generally cylindrical tubular upper pole section 12 suitably connected to an elongated, cylindrical, lower pole section 14. The lower distal end of the pole section 14 is suitably connected to a transverse handle part 16 which is preferably cylindrical in cross section, see FIG. 2B. The upper end of the pole section 12 is adapted to support a penetrating or cutting tip assembly 18 including a generally triangular shaped penetrating blade 20 having a tip 20a opposite a transverse edge 20b. Tip assembly 18 includes a generally cylindrical shank 22 having an axially tapered portion 22a which tapers toward the blade tip 20a. The cutting blade 20 is suitably mounted in a slot 23, FIG. 2A, formed in the shank 22 and may be secured therein by suitable means, including welding or mechanical fasteners, not shown.

The shank 22 is, in turn, suitably supported by the pole section 12 in bore 13 by spaced apart retaining pins 24, FIGS. 1 and 2A, which extend through suitable transverse bores 25 and 26 formed in the shank 22 and cooperating bores formed in the tubular pole section 12. As shown in FIG. 2A, the shank 22 is dimensioned to be a snug sliding fit within the bore 13 of pole section 12 and is suitably retained connected to the pole section as previously described and as shown in FIG. 2A. Accordingly, the press fitted pins 24 may be removed from the pole section 12 and shank 22 for replacement of the tip assembly 18, as needed or desired.

Referring further to FIG. 1, the firefighter's tool 10 includes a reciprocating piston hammer assembly 30 which is disposed in sleeved relationship over the pole section 14 and is slidable therealong for delivering impact blows to spaced apart generally cylindrical anvil members 32 and 34 which are suitably secured to the pole 10 as will be explained in further detail herein. The piston hammer assembly 30 is provided with an actuating and tool carrying handle 35 which is operable to be grasped to move the piston hammer assembly 30 axially between the anvils 32 and 34 for delivering repeated impact blows to the tool 10 for assistance in penetrating a wall or ceiling panel, for example, and for pulling the tool in the opposite direction with respect to the wall or ceiling panel in a manner which will provide for substantial assistance in ripping or pulling such panel away from its support structure to gain access to sources of fire, for example.

Referring further to FIGS. 2A and 2B, in one preferred embodiment, the lower pole section 14 is characterized by an elongated generally cylindrical rod member 38 having a slightly reduced diameter distal end portion 40 which is dimensioned to be disposed in bore 13 of upper pole section 12 in snug fitting relationship and retained connected to the upper pole section by spaced apart retaining pins 42 which extend through transverse bores 44 and 45 in rod portion 40 and cooperating bores 12b formed in the upper pole section 12, as shown in FIG. 2A. The solid rod member 38 may also be formed as a tubular member.

Generally cylindrical ring anvil member 34 is secured between a lower transverse face 12a of pole section 12 and an annular shoulder 40a formed on rod member 38. Preferably, a replaceable impact washer 43 is interposed the anvil 34 and piston hammer assembly 30 for receiving impact blows therefrom.

Referring further to FIGS. 2A and 2B, lower pole section 14 is further characterized, in one preferred embodiment, by a replaceable outer tubular bearing sleeve 48 which is sleeved over rod member 38 in snug fitting relationship and disposed between the anvil members 32 and 34. An annular groove 50 is formed in sleeve 48, FIG. 2A, and is cooperable with a locking screw 52, FIGS. 1 and 2B, for locking the piston hammer assembly 30 in a fixed position contiguous with or generally adjacent the anvil 34 to allow ease of carrying the tool 10 to and from a work site and for manipulating the tool 10 during ramming or penetrating a wall or ceiling panel, for example. Lock screw '52 includes a suitable easily manually manipulated thumb screw head 53, FIG. 2B, and is threadedly engaged with an elongated tubular hammer member 31 of the piston hammer assembly 30.

Tubular hammer 31 includes opposed annular transverse blow delivering impact flanges 33 and 37 for delivering repeated impact blows to the anvils 34 and 32, respectively. As shown in FIG. 2B, impact blow receiving anvil 32 may also be provided with an impact blow receiving ring or washer member 43 for direct engagement with flange 37. Piston hammer assembly 30 is snugly but freely slidably supported on lower pole section 14 by providing hammer member 31 with a suitable cylindrical bore 31a dimensioned to be a free sliding fit on pole section 14 and sleeve 48, in particular. As shown in FIG. 2B, anvil 32 is suitably secured against an annular shoulder 38b formed on rod member 38 by a slightly reduced diameter distal part 47. Handle 16 is suitably secured to a spigot part 49 of rod 38 extending from the reduced diameter part 47. Anvil 32 may be secured to rod 38 by welding or the like.

In operation, the tool 10 may be carried by placing the piston hammer assembly 30 in a position wherein the flange 33 is directly adjacent or in engagement with the anvil 34 which places the lock screw 52 generally in alignment with the groove 50. The lock screw 52 may then be tightened to secure the piston hammer assembly 30 in a preferred carrying position which places the center of gravity of the tool generally at the handle 35 to facilitate ease of carrying and use of the tool during an initial swinging motion, for example, to penetrate a wall or ceiling panel or for other manipulation purposes. In use, the tool may be grasped by the handles 16 and 35 and the blade 20 rammed through wall or ceiling paneling whereupon the lock screw 52 may be quickly rotated to release engagement of the screw with pole section 14 at the groove 50 so that the piston hammer assembly 30 can be grasped by the handle 35 and reciprocated.

Reciprocation of the piston hammer assembly 30 may be carried out by the firefighter manipulating the tool 10 or, while one firefighter holds the tool 10 by the handle 16 and, possibly, a portion of the upper pole section 12 another firefighter may actuate the piston hammer assembly 30 by grasping the handle 35 and rapidly reciprocating the piston hammer 31 to deliver impact blows to the anvils 32 and/or 34. Such action can aid in either penetrating wall or ceiling paneling with the tool 10 or removing the paneling by tearing it away from its supporting structure. The tool 10 has demonstrated improved performance for so-called firefighting pike poles or wrecking tools. The generously proportioned handle 35 permits ease of grasping the handle by a firefighter wearing somewhat bulky protective gloves. The transverse handle 16 aids in manipulation and forcing penetration of the tool.

In a preferred embodiment of the tool 10, the overall length is preferably between about 5.0 feet and 6.0 feet. The pole sections 12 and 14 are of approximately equal length. The pole section 12 is preferably formed of high strength aluminum tubing having an outside diameter of about 1.25 inches, for example. The lower pole section 14 is preferably characterized by the rod 38 being formed of about 1.0 inches diameter aluminum and the sleeve 48 being formed of stainless steel having a wall thickness of about 0.12 inches and sleeved over the rod 38 in snug fitting relationship. Piston hammer 31 is preferably formed of stainless steel having an outside diameter of about 1.50 inches and an overall length of about 12.0 inches. Conventional engineering materials, such as stainless steel and aluminum, may also be used for the remaining components of the tool 10, as previously described.

Referring briefly to FIG. 3, an alternate embodiment of a mechanism is illustrated for locking the piston hammer assembly 30 in a fixed position on pole section 14. As shown in FIG. 3, piston hammer assembly 30 is modified by including a radially projecting lug or pin 60 supported on flange 33 and projecting radially outwardly therefrom. A modified retaining pin 42a retains a tubular locking member 62 in sleeved relationship over pole section 12 and cylindrical anvil 34, as illustrated. Locking member 62 is biased into engagement with pin 42a by a coil spring 64 interposed a transverse wall 63 and the anvil 34. A so-called “J” slot 66 is formed in the locking sleeve 62 and opens to lower transverse face 67 of the sleeve.

With piston hammer assembly 30 positioned such that its flange 33 is directly adjacent or engaged with anvil washer 43, sleeve 62 may be pushed downwardly, viewing FIG. 3, so that pin 60 enters the “J” slot 66 whereupon either the piston hammer assembly 30 or the locking sleeve 62 may be rotated to cause the pin 60 to register in the portion 69 of the “J” slot under the urging of spring 64 to lock the piston hammer assembly 30 in a fixed position with respect to the pole section 14 for the same purposes as described above with respect to the embodiment shown in FIGS. 1, 2A and 2B. In other respects, the tool shown in FIG. 3 is identical to the embodiment shown in FIGS. 1, 2A and 2B.

Referring also briefly to FIG. 4, an alternate embodiment of a lower pole section for the firefighter's tool of the present invention is illustrated. The pole section illustrated in FIG. 4 may be an elongated cylindrical solid rod 14d, or a tubular member, and including an elongated cylindrical section 38d and opposed reduced diameter end parts 40d and 47d, together with a spigot part 49d. A piston hammer assembly locking groove 50d is formed in the rod section 38d. The lower pole section 14d may be formed as a solid rod, as a hollow tubular member and of a bearing material compatible with the piston hammer 31 to allow free reciprocating movement of the piston hammer assembly 30 therealong. The lower pole section 14d may be used in the tool 10 in place of the pole section 14 and does not require an outer bearing sleeve if formed of a suitable bearing material, such as stainless steel. The piston hammer 31 and the pole section 14d may be formed of other compatible materials to allow relatively low friction sliding movement between these two members.

The construction and operation of the tool 10 is believed to be readily understandable to those of ordinary skill in the art based on the foregoing description. A tool generally as described hereinabove will typically have a weight of about ten to eleven pounds and a center of gravity generally at the anvil 34 when the piston hammer assembly 30 is locked in its carrying or non-working position.

Although preferred embodiments of a firefighter's tool in accordance with the invention have been described in detail herein, those skilled in the art will recognize that various substitutions and modifications may be made without departing from the scope and spirit of the appended claims.

What is claimed is:

1. A firefighter's tool for penetrating a wall or ceiling panel comprising:
an elongated pole including a panel penetrating tip supported at one end thereof; and
a reciprocating piston hammer supported on said pole and operable to be reciprocated to deliver impact blows to said pole to assist in the use thereof.

2. The tool set forth in claim 1 including:
an anvil member supported on said pole and adapted to receive impact blows from said piston hammer to drive said tool in a direction to force said penetrating member to penetrate a panel.

3. The tool set forth in claim 1 including:
an anvil member supported on said pole and adapted to receive impact blows from said piston hammer to move said pole to pull a wall or ceiling panel away from supporting structure.

4. The tool set forth in claim 1 including:
spaced apart anvil members mounted on said pole, for receiving impact blows from said piston hammer when said piston hammer is moved in opposite directions along said pole.

5. The tool set forth in claim 4 wherein:
said pole comprises a first pole section supporting said penetrating tip and a second pole section connected to said first pole section, said piston hammer being slidably disposed on said second pole section between said anvil members.

6. The tool set forth in claim 5 wherein:
said second pole section includes a cylindrical part and said piston hammer comprises a tubular hammer disposed in sleeved relationship over said cylindrical part of said second pole section and a handle connected to said piston hammer for moving said piston hammer in opposite directions along said second pole section.

7. The tool set forth in claim 5 including:
a transverse handle connected to a distal end of said second pole section.

8. The tool set forth in claim 5 wherein:
said pole sections are secured together by transverse retaining pins disposed in cooperating bores formed in said pole sections, respectively.

9. The tool set forth in claim 5 including:
a locking member for locking said piston hammer in a predetermined position on said second pole section.

10. The tool set forth in claim 9 wherein:
said locking member comprises a screw mounted on said piston hammer and cooperable with a recess formed on said second pole section.

11. The tool set forth in claim 9 wherein:
said locking member comprises a sleeve having slot formed therein and engageable with a cooperating pin formed on said piston hammer for locking said piston hammer in a predetermined position on said second pole section.

12. The tool set forth in claim 1 wherein:
said penetrating tip includes a shank part and a penetrating blade mounted on said shank part, said shank part being releasably connected to a distal end of said pole.

13. The tool set forth in claim 12 wherein:
said shank part is secured to said pole by at least one retaining pin disposed in cooperating bores formed in said pole and said shank part.

14. A firefighter's tool for penetrating a wall or ceiling panel comprising:
an elongated pole including a first pole section supporting a penetrating tip at one end and a second pole section connected to said first pole section at an opposite end of said first pole section;
spaced apart anvil members supported on said pole; and
a reciprocating piston hammer supported on said pole and operable to be reciprocated to deliver impact blows to said anvils to assist in the use of said tool.

15. The tool set forth in claim 14 wherein:
said piston hammer comprises a tubular hammer disposed in sleeved relationship on said second pole section.

16. The tool set forth in claim 15 including:
a handle connected to said piston hammer for moving said piston hammer in opposite directions along said second pole section.

17. The tool set forth in claim 15 including:
a locking member for locking said piston hammer in a predetermined position on said second pole section.

18. The tool set forth in claim 14 including:
a transverse handle connected to a distal end of said second pole section.

19. The tool set forth in claim 14 wherein:
said penetrating tip includes a shank part and a penetrating blade mounted on said shank part, said shank part being releasably connected to said first pole section.

20. A firefighter's tool for penetrating a wall or ceiling panel comprising:
an elongated pole including a first pole section supporting a penetrating tip at one end and a second pole section connected to said first pole section at an opposite end of said first pole section;
spaced apart anvil members supported on said pole;
a reciprocating tubular piston hammer supported in sleeved relationship on said second pole section and operable to be reciprocated to deliver impact blows to said anvils to assist in the use of said tool;
a first handle connected to said piston hammer for moving said piston hammer in opposite directions along said second pole section;
a locking member for locking said piston hammer in a predetermined position on said pole; and
a second handle secured to a distal end of said second pole section.
